(19) United States
(12) Patent Application Publication
(10) Pub. No.: US 2019/0389337 A1
(43) Pub. Date: Dec. 26, 2019

(54) Foldable Car Seat

(71) Applicant: Robert Johnson, Union, NJ (US)

(72) Inventor: Robert Johnson, Union, NJ (US)

(21) Appl. No.: 16/452,449

(22) Filed: Jun. 25, 2019

Related U.S. Application Data
(60) Provisional application No. 62/689,411, filed on Jun. 25, 2018.

(51) Int. Cl. B60N 2/26; B60N 2/30

(52) U.S. Cl. CPC B60N 2/265; B60N 2/3086; B60N 2/3084

(57) ABSTRACT

Transporting children of differing sizes can be costly, since several seat configurations are required. Installing different seat configurations can be time-consuming, too. The invention comprises a foldable automobile seat that can be used to accommodate infants, toddlers, and bigger children, with a relocatable strap that can restrain the children.

### CROSS-REFERENCE TO RELATED APPLICATIONS

This application claims priority from U.S. Provisional Application Ser. No. 62/689,411 filed on Jun. 25, 2018, which is incorporated herein by reference in its entirety.

### FIELD

The present teachings relate to a foldable automobile seat that can accommodate children of different sizes.

### SUMMARY

Children of different sizes need different car seats. Infants, toddlers, and bigger children all have different car seat needs.

As a child grows, the need to buy different car seats can become quite costly. And removing an old seat and installing a new one as a child grows is time-consuming and inconvenient.

The present teachings include an automobile seat that has a car seat portion, a seat belt, a back portion and a bottom portion. The car seat portion is foldable from the back portion to reveal a child seat.

The car seat portion suitable for a toddler can be deployed from the back portion of the automobile seat to reveal a front-facing position. In this position, the contact region, i.e., the part of the car seat portion in contact with the toddler or the toddler's back, is positioned so that the toddler is facing the front of the car. The car seat portion suitable for an infant has a rear-facing position. In this configuration, the contact region is positioned so that the infant faces the rear of the car. The back surface of the car seat portion suitable for an infant (in the rear-facing position) must be high enough for the infant's head to rest on the back surface in the rear-facing position. The distance between this back surface and the back portion should be sufficient for the infant to sit comfortably and be able to stretch their legs and arms. The width of this back surface should be greater than the width of the infant. The booster position, suitable for bigger children, also has a contact region that positions the child to be facing toward the front of the car.

For the car seat portions suitable for an infant and toddler (in the rear-facing position and front-facing position, respectively), a strap restrains the child's shoulders and pelvis. For the car seat portion suitable for a bigger child (in the booster position), a seat belt is the restraint. Because the seat configuration for the infant (rear-facing position) and toddler (front-facing position) differs, the strap is relocatable; it moves based on the seat configuration.

In the booster position, the child seat boosts the child higher. In some examples, the child's larger size combined with the vertically upward boost allows for the seat belt to safely restrain the larger child.

When in the stowed position, the car seat portion is pulled up and returned to the back portion. The seat bottom of the car seat portion is always in contact with the bottom portion of the automobile seat, regardless of whether the car seat portion is in the front-facing position, rear-facing position, or booster position.

In some examples, the child car seat does not have a lap bar, contracting piston, or padded bar restraint.

In another embodiment, when the car seat portion is deployed to reveal the forward-facing position, the part of the car seat portion that is parallel to the bottom portion of the automobile seat can be pulled or folded out to configure the rear-facing position.

In another embodiment, the automobile seat can be retrofitted into a vehicle or used as a standalone and placed on a conventional car seat. The option also exists for the car seat portion suitable for an infant (the rear-facing configuration) to be pulled out from the bottom portion of the automobile seat. For the rear-facing configuration to be stowed, it is pushed back down into the bottom portion of the automobile seat.

In yet another embodiment, remote controllability of the car seat portion allows the car seat portion to be deployed automatically. In addition, the automobile seat can be heated or cooled for the child's comfort.

These and other features, aspects and advantages of the present teachings will become better understood with reference to the following description, examples and appended claims.

### BRIEF DESCRIPTION OF THE DRAWINGS

Those of skill in the art will understand that the drawings, described below, are for illustrative purposes only. The drawings are not intended to limit the scope of the present teachings in any way.

FIG. 1A-B. A side perspective view of an automobile seat with a car seat portion in the rear-facing position and a front perspective view of an automobile seat with a car seat portion in the front-facing position, with an infant in a rear-facing position (1A) and a toddler in a front-facing position (1B) with a strap restraining them at their shoulders and pelvis.

FIG. 2. A perspective view of an automobile seat with a car seat portion in a stowed position.

FIG. 3. A perspective view of an automobile seat with a car seat portion deployed in a front-facing position, with a strap restraining the shoulders and pelvis and a seat belt present.

FIG. 4. A perspective side view of an automobile seat with a car seat portion in a rear-facing position showing a strap that restrains the shoulders and pelvis.

FIG. 5. A perspective front view of an automobile seat with a car seat portion in a booster position, with a seat belt restraining a larger child.

### DETAILED DESCRIPTION

Many aspects of the invention can be better understood with the references made to the drawings below. The components in the drawings are not necessarily drawn to scale. Instead, emphasis is placed on clearly illustrating the components of the present invention. Moreover, like reference numerals designate corresponding parts through the several views of the drawings.

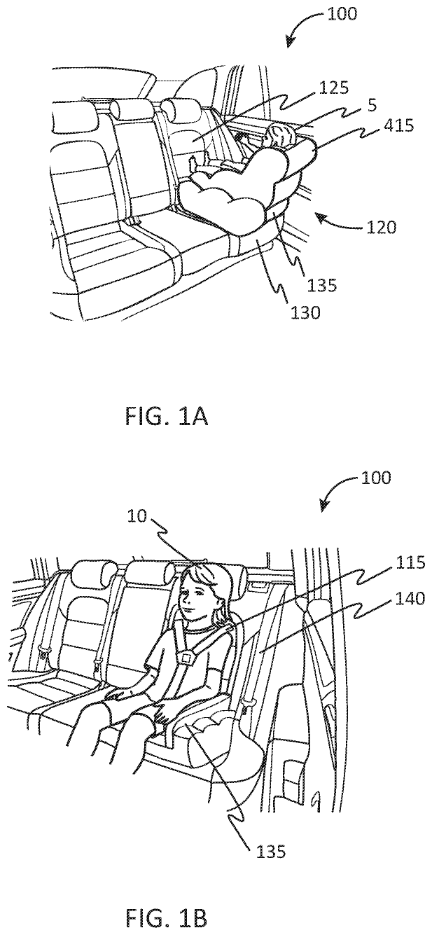

FIG. 1A-B shows an automobile seat 100 with a car seat portion 120 in the rear-facing position (1A) and front-facing position (1B). The infant 5 in FIG. 1A is facing toward the rear of the vehicle. In FIG. 1B, the car seat portion 120 is in the front-facing position, with the toddler 10 facing toward the front of the vehicle. A strap 115 restrains the toddler's 10 shoulders and pelvis. The car seat portion 120 is deployed from the back portion 125 of the automobile seat. The bottom portion 130 of the automobile seat 100 is in contact with the car seat bottom 135.

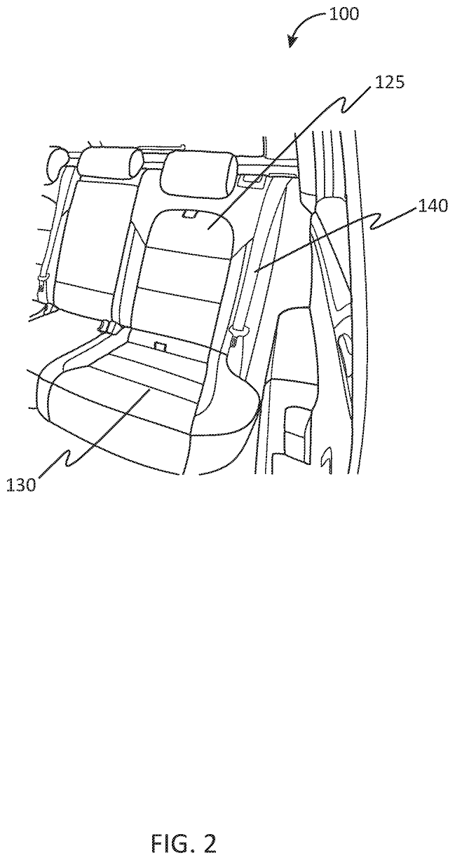

FIG. 2 is a view of an automobile seat 100 in the stowed position. The car seat portion 120 is disposed or stored in the back portion 125.

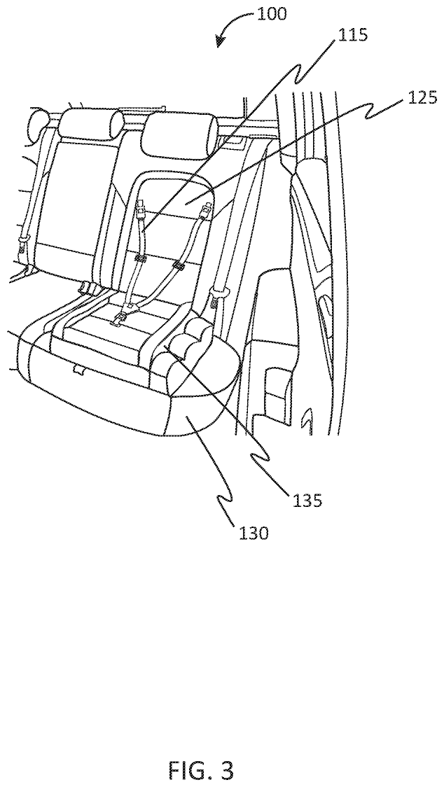

FIG. 3 shows a view of an automobile seat 100 with a car seat portion 120 deployed in a front-facing position, with a strap 115 and a seat belt 140 present. The strap 115 is relocatable; it can be moved depending on the child being transported. An infant 5 and toddler 10 can both be transported with the strap 115, since both sizes of children require restraint at the shoulders and pelvis. A larger child can be transported with the seat belt 140.

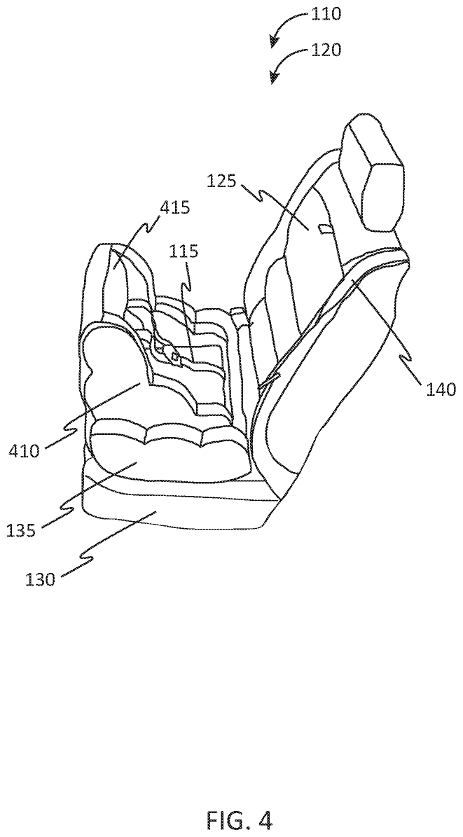

FIG. 4 is a side view of an automobile seat 100 with a car seat portion 120 in a rear-facing position showing a strap 115 that restrains the shoulders and pelvis. Infant width panels 410 should be wide enough to accommodate an infant 5 comfortably (i.e., the infant 5 should not be spilling out of the infant width panels 410) and for the strap 115 to secure the infant 5. The location of the strap 115 for an infant 5 differs than that for a toddler 10, which is the reason why the strap 115 is relocatable. An infant headrest 415 should be high enough to support the head of an infant 5. The head of an infant 5 should not fully clear the headrest 415. As seen in FIG. 1A, the head of the infant 5 is stabilized and not free to flop around. The distance between the headrest 415 and the back portion 125 should be great enough for an infant 5 to stretch its arms and legs without difficulty.

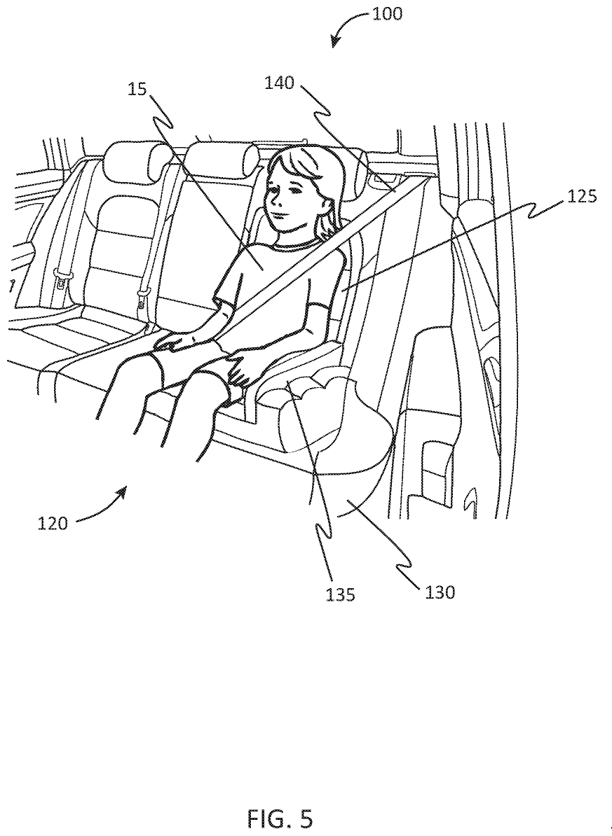

FIG. 5 is a view of a big child 15 in a booster position, restrained by a seat belt 140. In the booster position, the big child 15 is facing toward the front of the car. The car seat portion 120 is deployed from the back portion 125 and is returned to the back portion 125 for stowing purposes. In contrast to the toddler 10, the big child 15 can be retrained with a seat belt 140; restraint of the shoulders and pelvis is not as critical for the big child 15 because seat belt 140 can adequately restrain child 15. The seat bottom 135 of the car seat portion 120 is in contact with the bottom portion 130 when the car seat portion 120 is in use.

### OTHER EMBODIMENTS

The detailed description set-forth above is provided to aid those skilled in the art in practicing the present invention. However, the invention described and claimed herein is not to be limited in scope by the specific embodiments herein disclosed because these embodiments are intended as illustration of several aspects of the invention. Any equivalent embodiments are intended to be within the scope of this invention. Indeed, various modifications of the invention in addition to those shown and described herein will become apparent to those skilled in the art from the foregoing description which do not depart from the spirit or scope of the present inventive discovery. Such modifications are also intended to fall within the scope of the appended claims.

What is claimed is:

1. An automobile seat having a bottom portion, a back portion, a seat belt, and a car seat portion wherein the car seat portion is foldable among a rear-facing position, front-facing position, booster position, and stowed position.

2. The seat of claim 1 wherein the rear-facing position has a contact region facing a car back end.

3. The seat of claim 2 wherein the booster position has a contact region facing a car front end.

4. The seat of claim 3 wherein the front-facing position has a contact region facing a car front end.

5. The seat of claim 4 wherein the booster position has a contact region facing a car front end.

6. The seat of claim 5 wherein, in the rear-facing position, the car seat has a strap that is positioned such that the strap restrains the shoulders and pelvis of a user.

7. The seat of claim 6 wherein, in the front-facing position, the car seat has a strap that is positioned such that the strap restrains the shoulders and pelvis of a user

8. The seat of claim 7 wherein, in the booster position, the car seat is positioned such that the seat belt restrains a user.

9. The seat of claim 8 wherein, in the stowed position, the car seat portion is disposed in the back portion.

10. The seat of claim 9 wherein the car seat portion has a seat bottom that rests on the automobile seat bottom portion when in either of the rear-facing position, in the front-facing position, or in the booster position.

11. The seat of claim 10 wherein the strap is relocatable.

12. The seat of claim 11 wherein the automobile seat does not have a lap bar, a contracting piston, or a padded bar restraint.

13. The seat of claim 1 wherein
the front-facing position has a contact region facing a car front end
and
the booster position has a contact region facing a car front end.

14. The seat of claim 5 wherein, in the front-facing position, the car seat has a strap that is positioned such that the strap restrains the shoulders and pelvis of a user

15. The seat of claim 14 wherein the car seat portion stores in the back portion.

16. The seat of claim 14 wherein the car seat portion has a seat bottom that rests on the automobile seat bottom portion when in either of the rear-facing position, in the front-facing position, or in the booster position.

17. The seat of claim 5 wherein, in the booster position the car seat is positioned such that the seat belt restrains a user.

18. The seat of claim 17 wherein the car seat portion stores in the back portion.

19. The seat of claim 1 wherein the automobile seat does not have a lap bar, a contracting piston, or a padded bar restraint.

20. An automobile seat having a bottom portion, a back portion, a seat belt, and a car seat portion wherein the car seat portion is foldable among
a rear-facing position having a contact region facing a car back end and having a relocatable strap that is positioned such that the strap restrains the shoulders and pelvis of a user,
a front-facing position having a contact region facing a car front end and having a relocatable strap that is positioned such that the strap restrains the shoulders and pelvis of a user,
a booster position having a contact region facing a car front end wherein the car seat is positioned such that the seat belt restrains a user,
and
a stowed position in which the car seat portion is disposed in the back portion,
wherein
the car seat portion has a seat bottom that rests on the automobile seat bottom portion when in either of the rear-facing position, in the front-facing position, or in the booster position
and
the automobile seat does not have a lap bar, a contracting piston, or a padded bar restraint.
